(19) United States
(12) Patent Application Publication
(10) Pub. No.: US 2007/0212472 A1
(43) Pub. Date: Sep. 13, 2007

(54) SOYBEAN FLOUR AND METHOD FOR THE PRODUCTION THEREOF

(75) Inventors: Anton Holenstein, Pfungen (CH); Michel Gavin, Winterthur (CH); Carlo Bogoni, Winterthur (CH)

Correspondence Address: GREENBLUM & BERNSTEIN, P.L.C., 1950 ROLAND CLARKE PLACE, RESTON, VA, 20191, US

(73) Assignee: BUEHLER AG, Uzwil (CH)

(21) Appl. No.: 11/574,210

(22) PCT Filed: Jul. 21, 2005
(86) PCT No.: PCT/CH05/00428

§ 371 Date: Feb. 23, 2007

(30) Foreign Application Priority Data
Aug. 26, 2004 (DE) 10 2004 041 578.1

(51) Int. Cl. A23L 1/20

(52) U.S. Cl. 426/634

(57) ABSTRACT

The invention relates to a method for producing soybean flour consisting of soybeans. said method comprising the followving steps: a) the soybeans are husked to a husking degree of more than 97%; b) the husked soybeans are ground to a particle-size distribution whereby more than 60% of the soybean particles measures between 50 μm and 0.5 mm and more than 30% of the soybean particles (fine part) measures less than 50 mm. by subjecting the same to a percussive force; c) an enzyme system of the soybean particles is deactivated and the soybean particles are agglomerated; and d) the agglomerates comprising the deactivated soybean particles are finely ground to a particle size distribution whereby at least 98% of the particles is smaller than 100 μm by subjecting the agglomerates and the deactivated soybean particles thereof to shear forces. The invention also relates to a soybean flour that is preferably produced by the inventive method, the maximum particle size being smaller than 100 μm, the soybean enzyme system having been at least partially deactivated by heat. and the husk content being less than 0.3 wt. %

This invention relates to soy flour, in particular to flavor-neutral soy flour, and a method for its manufacture.

There are numerous known methods for manufacturing soy flour.

The at times unpleasant flavor of soybeans is caused first and foremost by the activity of the enzymes present in the soybeans.

If enzymes are not inactivated correctly, unacceptable changes in product flavor can be encountered. However, enzyme inactivation is associated with the risk of destroying valuable soybean phytochemicals.

Therefore, the problem encountered during the manufacture of soy flour or any soy flour extract for basic use in foods and nutraceutics has to do with the fact that it is very difficult and expensive, if not impossible, to obtain a product still having the full nutritional and physiological value of the parent material, while simultaneously devoid of the typical bean flavor of soy products.

The object of this invention is to provide a new type of method for manufacturing soy flour that does not have these disadvantages.

This object is achieved by the method according to claim 1 and the soy flour according to claim 23.

According to the invention, the method for manufacturing soy flour out of soybeans involves the following steps:

a) Husking of soybeans to a husking degree exceeding 97%;

b) Comminuting of husked soybeans to a particle size distribution at which more than 60% of the soybean particles range in size from 50 μm to 0.5 mm, and more than 20% of the soybean particles (fines) are less than 50 μm in size, by subjecting the husked soybeans to impact forces;

c) Deactivation of an enzyme system of the soybean particles and agglomeration of the soybean particles to form agglomerates;

d) Fine comminuting of agglomerates with deactivated soybean particles to a particle size distribution at which at least 98% of the particles are less than 100 μm in size by subjecting the agglomerates and their deactivated soybean particles to shearing forces.

The husking of soybeans to a husking degree exceeding 97% (step a) is a precondition for the subsequent comminuting of soybeans by means of shearing forces (step d). Since more than 97% of the husks are removed, only a very few husk particles remain in the mixture after the steps for comminuting and size standardization, as well as for deactivation, have been implemented. If too many of such husk particles remain behind in the mixture to be comminuted, it would be impossible to achieve a correct comminuting. In this case, 90% of the particles are smaller than 60 μm after step d). 50% of the particles are preferably smaller than 20 μm.

The husked particles are comminuted to a size distribution at which 60% of the soybean particles range from 50 μm to 0.5 mm and more than 20% of the soybean particles (fines) measure less than 50 μm in size by subjecting the husked soybeans to impact forces. Step b) is a precondition for subsequent deactivation having as uniform and sufficient an effect on the product to be deactivated, and for an agglomeration to take place in step c), wherein the fines during agglomeration help to bond the relatively large particles from the coarse portion into agglomerates.

It was surprisingly found that fine comminuting (micro-grinding) through exposure of previously comminuted, deactivated and agglomerated particles (steps a, b and c) to shearing forces (step d) to a particle size distribution at which at least 98% of the particles are smaller than 100 μm has a favorable effect on the oral sensation of the soybean flour, without impairing its nutritional and physiological value.

Therefore obtained is soy flour that has no bean flavor after thermal treatment, but is rather flavor-neutral, and does not taste like sand when used in products.

In this text, the term “nutritional and physiological value” relates to the entire range of physiological useful constituents of soybeans, including typical bioactive soy contents, e.g., isoflavons, tocopherols, etc.

As a rule, the husking step (a) is performed on whole soybeans.

Husking in step a) can take place using an impact husker, e.g., a percussion husking machine. Use is preferably made of a percussion husking machine with a nip distance for the impact basket of 0.4 mm to 0.8 mm, even more preferably with a nip distance of 0.6 mm.

While being husked in step a), the soybeans are preferably exposed to air with a temperature ranging from about 115° C. to 120° C. As a result, this “hot husking’ is performed at soybean temperatures ranging from 80° C. to 90° C.

The husked soybeans are preferably comminuted in step b) in an atmosphere with less than 10% v/v oxygen, preferably in a mixture of air and nitrogen, in order to avoid oxidative damage to the product, and prevent impairment to its nutritional and physiological value.

Comminuting in step b) can take place using a hammer mill.

The husked soybeans are preferably comminuted, thereby yielding a particle size distribution at which 60% of the soybean particles range from 60 μm to 0.5 mm (coarse portion). Comminuting the product to such an average size prior to thermal deactivation ensures that all comminuted product particles are subjected to essentially the same thermal treatment on both their surface and inside. This makes it possible to achieve a uniform product deactivation, as already mentioned further above.

The comminuted soybean particles are best deactivated in step c) at saturated steam temperatures in a saturated steam atmosphere or at temperatures of 90° C. to 100° C., preferably at 95° C. to 99° C.

Deactivation in step c) preferably takes place over a period of 1 min to 10 min, in particular over 100 s to 200 s.

Deactivation in step c) preferably takes place by moistening and heating with saturated steam, and exposing the soybean particles to the moisture, wherein moistening preferably takes place with steam to a water content of 15 to 20% w/w. The steam dissolves sticky soy constituents out of the fine particles, thereby facilitating agglomerate formation in step c).

Deactivation in step c) can take place in a conditioner using a processing screw. As an alternative, it can take place using an extruder.

In a particularly preferred embodiment of the method according to the invention, fine comminuting in step d) takes place using a distributor mill.

Fine comminuting in step d) can take place in a distributor mill with at least two, and preferably three rolls varying in speed. These rolls exert pressure, friction and shearing forces on the product in the roll nips.

The fine comminuting via a distributor roll in step d) preferably is preceded by a step for setting the moisture, in which the deactivated, comminuted and agglomerated soybean particles are set to a moisture value of 8 to 12% w/w, preferably of 9 to 11% w/w.

The moisture-setting step is preferably executed thermo-pneumatically. This drying process preferably takes place in a fluidized-bed dryer with forced conveyance, or in a tumbler dryer. The dried agglomerates are subsequently pneumatically transported on for fine comminuting. Since the soybean particles are agglomerated, the fines are bound. As a result, dust formation is slight, so that less product is lost or jams the air filter.

Particles measuring from 5 μm to 100 μm, more preferably from 10 μm to 50 μm, are preferably generated in the fine comminuting step d).

In another advantageous embodiment, husking in step a) is followed by pressing oil out of the soybeans in order to achieve a fat content of 8% to 12% relative to dry mass. The soybeans expressed in this way are then routed to the additional steps b), c) and d). A fat content in the mentioned area also has a positive effect on fine comminuting with a distributor mill.

Agglomeration along with the aforementioned setting of fat content and water content have a positive effect on fine comminuting in the distributor mill.

The soy flour according to the invention, in particular manufactured based on the method according to the invention, has a maximum particle size of less than 100 μm, wherein the soybean enzyme system is for the most part deactivated, and the husk content is less than 0.3 % w/w.

Its maximum particle size preferably ranges from 5 μm to 100 μm, and preferably from 10 μm to 50 μm.

The protein content in the manufactured soy flour is preferably greater than the protein content of the initial soybeans.

The nutritional fiber content or raw fiber content in the manufactured soy flour is preferably less than 50% of the nutritional fiber content or raw fiber content of the initial soybeans.

The lipoxygenase content of the manufactured soy flour is preferably less than 0.02% of the lipoxygenase content of the initial soybeans. (?!)

The oil content of the manufactured soy flour can be greater than the oil content of the initial soybeans.

The nitrogen solubility index (NSI) of the manufactured soy flour is preferably greater than 45% of the NSI of the initial soybeans.

The isoflavonoid content of the manufactured soy flour is preferably greater than 100% of the isoflavonoid content of the initial soybeans.

The particle size distribution of the manufactured soy flour is preferably such that more than 30% of the flour particles are less than 10 μm.

The trypsin-inhibitor content of the manufactured soy flour is preferably less than 50% of the trypsin-inhibitor content of the initial soybeans.

The soy flour manufactured with the method according to the invention can be used as an additive in food products, e.g., dairy products, fruit products, beverages, soups, pasta, food bars, meat substitutes, snacks, frozen desserts and baked products.

The fine comminuting step d) is preferably preceded by a moisture-setting step, in which the moisture of the deactivated, comminuted and husked soybeans (steps a and b) are set to a moisture value of 8 to 12 % w/w, preferably 9 to 11% w/w. In most instances, the soybean particles must be dried, and the moisture-setting step is performed. It was surprisingly found that fine comminuting at such moisture values improves the flavor of the product by eliminating the bean flavor, and replacing it with a lack of flavor or empty flavor, and/or a somewhat malt-like flavor. This empty or “neutral” flavor is important in cases where the soy flour is added to food products that can have varying types of flavors and are not to be impaired by the taste of the additive.

The method according to the invention is preferably implemented as a continuous process.

Other aspects, advantages and applications of this invention can be gleaned from the further description below and based on the drawing, wherein:

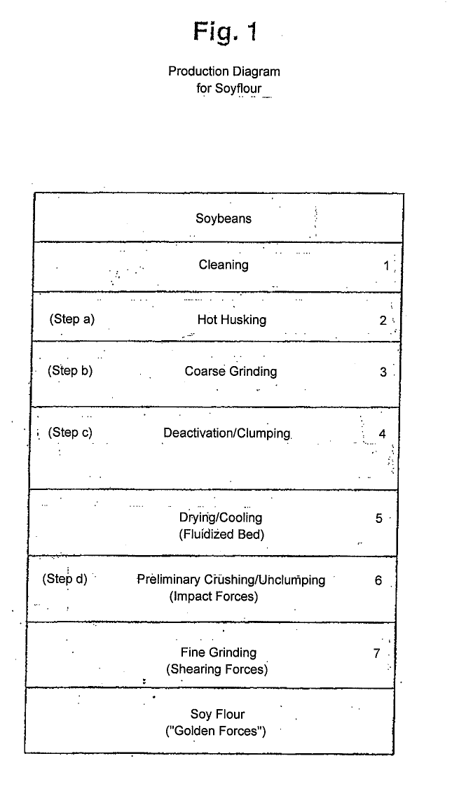

FIG. 1 shows a schematic production diagram for implementing the method according to the invention;

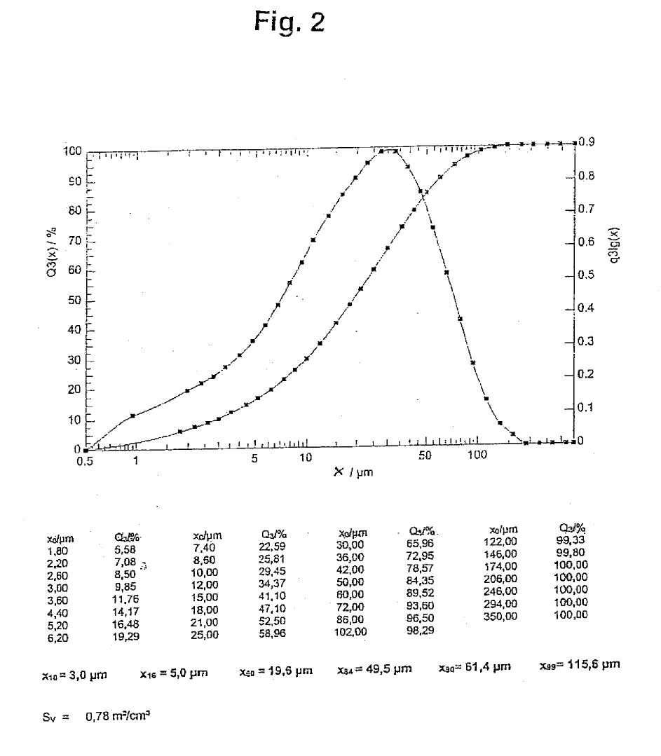

FIG. 2 shows the particle size distribution of a first fine soy flour according to the invention;

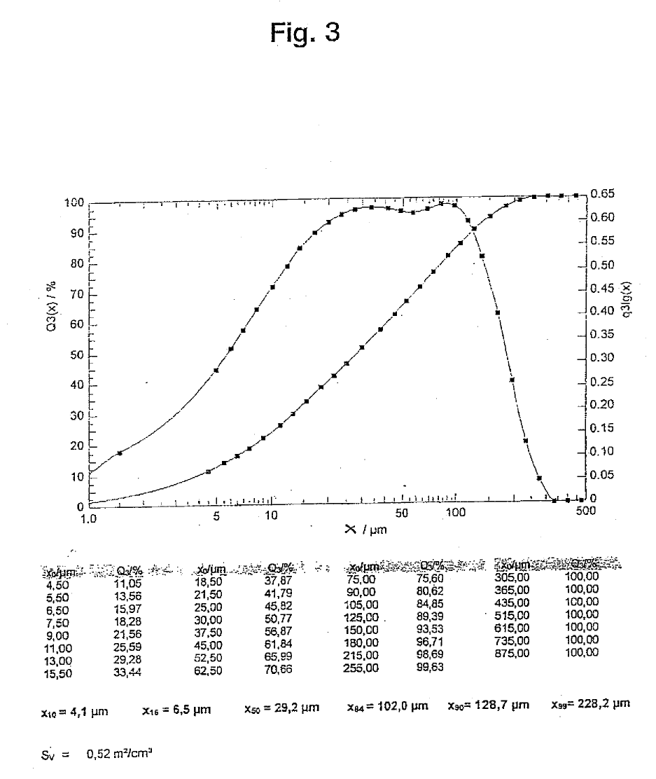

FIG. 3 shows the particle size distribution of a second fine soy flour according to the invention;

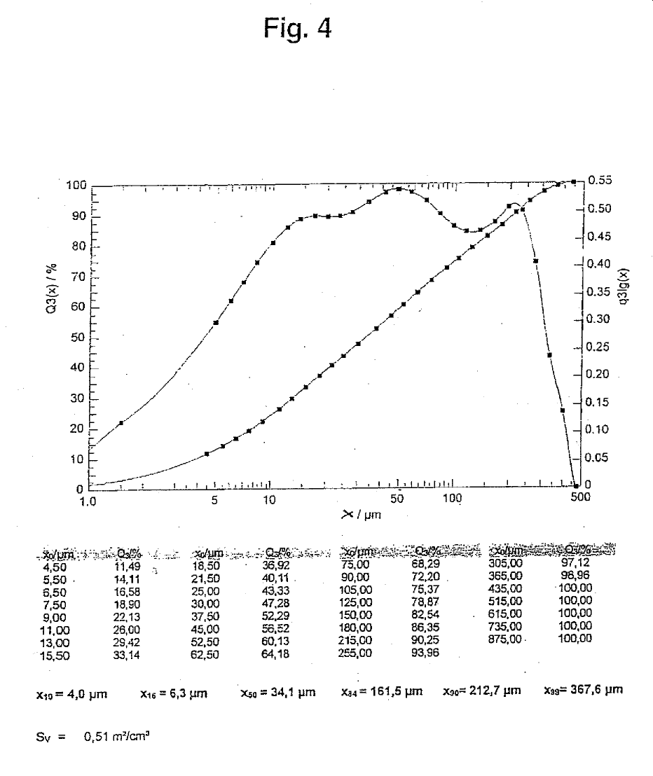

FIG. 4 shows the particle size distribution of a third fine soy flour according to the invention.

FIG. 1 presents a schematic production diagram for manufacturing the soy flour according to the invention.

In a first step, the soybeans are cleaned as the initial product using a conventional purification process.

In a second step, the cleaned soybeans are husked in a hot husking process. During this hot husking, the soybeans are exposed to air with a temperature of 115° C. to 120° C., and husked in an impact husker or a percussion husking machine. A husking degree exceeding 97% can be achieved in this way, without having to accept any notable thermal damage to the desired soy constituents.

In a third step, the husked soybeans are comminuted in a coarse milling process. During this coarse milling, the husked soybeans are exposed to impact forces. A hammer mill is used for this purpose. Instead of working in conventional air, an inert atmosphere can be produced in the hammer mill by adding nitrogen to the atmosphere, in which an oxygen share of less than 10 v/v % is present in the hammer mill. The particle size distribution after this coarse milling is characterized in that more than 60% of the soybean particles range in size (coarse share) from 50 μm to 0.5 mm, and more than 20% of the soybean particles measure less than 50 μm in size (fines).

In a fourth step, the husked and coarsely milled soybeans, i.e., the coarse portion and fine portion, are subjected to a hydrothermal treatment to deactivate and agglomerate the coarsely milled soybean particles. Used to this end is a chamber with mixing screw, in which the soybean particles are exposed to hot water and steam for a total retention time of at least 2 min, wherein the temperature in the chamber lies close to the temperature of saturated steam at ambient pressure. Roughly 10% w/w water and steam are added to the coarsely milled soybeans. The wetted and softened soybean particles are constantly moved inside the chamber, thoroughly mixing together the coarse and fine shares. Exposure to the steam makes the particles sticky, so that an agglomeration takes place. The coarser particles of the coarse share are here bonded by the finer particles of the fines.

In a fifth step, the deactivated and agglomerated soybean particles are dried. To this end, a fluidized bed with forced conveyance is used. The retention time or throughput time measures at least 3 min at a drying temperature of 80° C. Toward the end of the retention time, cooling to ambient temperature takes place. A moisture of 8 to 12 % w/w water is set for the agglomerates treated in this way.

In a sixth step, the agglomerates obtained in the fourth step and dried, cooled and remoistened in the fifth step (conditioned agglomerates) are pre-comminuted. This essentially involves a deagglomeration of the agglomerates. For example, an impact mill is used for this purpose. Use is preferably made of an impact mill with a nip distance at the impact screen of 1.5 mm to 2.5 mm, and even more preferably with a nip distance of 2 mm.

In a seventh step, agglomerates composed of the coarse and fine portion (residual agglomerates) are comminuted via fine milling. In this fine milling process, the agglomerates are exposed to shearing forces. Used to this end is a distributor mill, e.g., having three sequential roll pairs with a respective friction nip. The roll pairs for each of the two passages tightly abut, and run opposite each other at a different speed, giving rise to a velocity difference between the roll surfaces in the friction nip. The particle size distribution after this fine milling process is characterized in that at least 98% of the soybean particles arc smaller than 100 μm. The specific surface of the fine soy flour according to the invention obtained in this way ranges from 50 to 80 m²/cm³. Throughputs ranging from 8 to 10 kg/(h x cm) were achieved in the distributor mill (per hour and per centimeter of roll length).

The soybeans are here transported from one treatment step to the next gravimetrically or via conveyor belts, while the comminuted, i.e., coarsely milled or finely milled soybeans, or the agglomerated soybean particles are transported from one treatment step to the next pneumatically.

FIG. 2, FIG. 3 and FIG. 4 show the respective particle size distribution for a first, a second and a third fine soy flour according to the invention.

The horizontal axis is a logarithmic scale of particle size x in μm. The vertical axis on the left side is a linear scale of the distribution sum Q3(x) as a function of particle size x. The vertical axis on the right side is a linear scale of distribution density q31g(x) as a function of the particle size x.

This particle size analysis was performed by means of laser diffraction using the fine soy flour according to the invention, which was suspended in isopropyl alcohol for this purpose.

On FIG. 2, 3 and 4, the following mean:

| | |
|---|---|
| Q3(x)/% | Distribution sum in percent |
| q31g(x) | Distribution density |
| x | Particle size |
| x₀/μm | Particle size (upper class limit) |
| Sᵥ | Specific surface |

The soy process according to the invention consists of husking, milling, thermal enzyme activation to reduce the undesired bean flavor (by controlling the supply of heat and moisture to the milled soy, thereby inactivating specific enzymes, while preserving the nutritional, physiological and functional integrity of the macronutrients and bioactive constituents of the soy) and micromilling to generate soy flour particles ranging from 0.5 μm to 150 μm, preferably from 5 μm to 50 μm.

The soy flour according to the invention can also be used to manufacture an economical and nutritious soymilk by adding water and active agents for setting an oral sensation and the viscosity by means of special mixing process, in which mixing takes place at a high shear and, for example, a ball mill is used.

For example, the following two methods can be used for manufacturing soymilk:

The soy flour according to the invention is suspended in an aqueous system using a hydrocolloid. Sweeteners and/or other flavorings can be added. This yields a beverage with a consistency similar to a milk mix beverage.

The soy flour particles according to he invention are encapsulated with a hydrocolloid using a ball mill. This ball mill process uses a relatively high viscous mixture of soy flour, water and a hydrocolloid. After milling in the ball mill, the mixture is diluted to a certain protein content, which provides for a specific quantity of protein per portion. Since the soy flour according to the invention is taste-neutral or has a pleasant flavor, it is suitable for mixing with numerous food additives, such as flavorings, vegetable powder, fruit powder, phytonutrients, plant extracts, hydrocolloids, vitamins, minerals, trace elements, etc., to fabricate a dispersible, instant food mixture.

The soy flour according to the invention can be used to manufacture soy products at reduced costs. For example, expensive soy isolates can be substituted with soy protein extracts enriched with, for example, isoflavonoids, etc.

The soy flour according to the invention has a high percentage of bioactive substances.

The soy flour according to the invention does not result in any increase in the glycemic index (GI). A correct combination with hydrocolloids can even lower the GI.

The soy flour according to the invention is easily digestible.

The soy flour according to the invention does not produce a sandy taste when used in liquid or semi-liquid products given the addition of hydrocolloids.

It is assumed that the soy flour according to the invention or flours containing it are characterized by a high bioavailability of bioactive substances and micronutrients.

The soy flour according to the invention generates improved texture properties as a finely milled additive combination.

The soy additive according to the invention is not necessarily provided as soy flour. Rather, it can be provided in the form of a liquid additive, e.g., oil or fat, at the end of soy flour production, as a paste or liquid preferably sterilized beforehand.

In a manner similar to the soy flour according to the invention, flours based on cereal grains, beans and legumes, etc., can be manufactured that have similar properties to the soy flour according to the invention in terms of flavor.

1. The method for preparing a soy flour from soy beans wherein the method includes the following steps:
a) Husking the soy beans until the beans are more than 97% husked;
b) Grinding the husked soy beans via coarse grinding to a particle size distribution in which more than 60% of the soy bean particles that form a coarse portion are in the size range from 50 μm to 0.5 mm and more than 20% of the soy bean particles that form a fine portion are in the size range less than 50 μm by subjecting the husked soy beans to crushing forces;
c) Deactivating an enzyme system of the soy bean particles and agglomerating the soy bean particles to form clumps by subjecting the coarse portion and fine portion to hydrothermal treatment, in which use is made of a chamber with a mixing screw, after which the deactivated and agglomerated soy bean particles are dried, for which a fluidized bed with forced feeding is used;
d) Finely grinding the clumps containing deactivated soy bean particles to a particle size distribution in which 98% of the particles are smaller than 100 μm by initially subjecting the clumps and their deactivated soy bean particles to impact stresses, and then to shear stresses.

2. The method according to claim 1, characterised in that the husking step a) is performed on whole soy beans.

3. The method according to claim 1, characterised in that the husking in step a) is performed using an impact husker.

4. The method according to claim 3, characterised in that the husking of step a) is performed with a beating husker.

5. The method according to claim 1, characterised in that during the husking in step a) the soy beans are exposed to air temperatures of about 115-120° C.

6. The method according to claim 1, characterised in that the grinding and agglomeration in step b) is performed in an atmosphere containing less than 10% by volume oxygen, preferably in a mixture of air and nitrogen.

7. The method according to claim 1, characterised in that the grinding in step a) is performed using a hammer mill.

8. The method according to claim 1, characterised in that the husked soy beans are ground and their size is standardized to obtain a particle size distribution in which 60% of the soy bean particles (coarse portion) are in the range from 50 μm to 500 μm.

9. The method according to claim 1, characterised in that in step c) the ground soy bean particles are deactivated at temperatures from 90° C. to 100° C., particularly from 95° C. to 100° C.

10. The method according to claim 9, characterised in that the deactivation in step c) is performed for a period of less than 5 min, particularly for a period between 100 s and 200 s.

11. The method according to claim 1, characterised in that the deactivation in step c) is carried out by moistening, heating, and allowing moisture to act on the soy bean particles that have been ground and standardized in size.

12. The method according to claim 11, characterised in that the soy bean particles are moistened with water and water vapor until they have a moisture content of 15 to 20% by weight.

13. The method according to claim 1, characterised in that the deactivation in step c) is performed using an extruder.

14. The method according to claim 1, characterised in that the clumps obtained in step c) are pre-ground, wherein at least partial deagglomeration of the clumps takes place.

15. The method according to claim 14, characterised in that an impact mill is used for the deagglomeration.

16. The method according to claim 1, characterised in that the fine grinding in step d) is performed using a friction roller mill.

17. The method according to claim 16, characterised in that the fine grinding in step d) is performed in a friction roller mill.

18. The method according to claim 16, characterised in that the fine grinding in step d) is preceded by a step for adjusting moisture, in which the moisture content of the deactivated, ground and agglomerated soy bean particles is adjusted to a value of 8 to 12% by weight, preferably 9 to 11% by weight.

19. The method according to claim 1, characterised in that the fine grinding step d) produces particles from 50 μm to 100 μm, preferably in the range from 5 μm to 50 μm.

20. The method according to claim 1, characterised in that after grinding in step d), more than 50% of the particles are smaller than 20 μm.

21. The method according to claim 1, characterised in that after husking in step a), oil is pressed out of the soy beans to obtain a fat content of 8% to 12% relative to the dry matter.

22. A soy flour, particularly as produced by the method according to claim 1, in which the maximum particle size is smaller than 100 μm, in which the soy bean enzyme system is at least partially, particularly to a degree exceeding 70%, thermally deactivated, and the husk content thereof is less than 0.3% by weight.

23. The soy flour according to claim 22, characterised in that the maximum particle size is in the range from 0.5 μm to 100 μm, preferably in the range from 5 μm to 50 μm.

24. The soy flour according to claim 22, characterised in that protein content of the soy flour produced is greater than 100% of the protein content of the original soy beans.

25. The soy flour according to claim 24, characterised in that the dietary or crude fiber content of the soy flour produced is less than 50% of the dietary or crude fiber content in the original soy beans.

26. The soy flour according to claim 24, characterised in that the lipoxygenase content of the soy flour produced is less than 0.02% of the lipoxygenase content in the original soy beans.

27. Soy beans according to claim 22, characterised in that the oil content of the soy flour produced is greater than the oil content in the original soy beans.

28. The soy flour according to claim 22, characterised in that the nitrogen solubility index (NSI) in the soy flour produced is more than 60% as high as the NSI of the original soy beans.

29. The soy flour according to claim 22, characterised in that the soy flour produced contains more than 100% isoflavonoids compared with the isoflavonoid content of the original soy beans.

30. The soy flour according to claim 22, characterised in that the particle size distribution of the soy flour produced is such that more than 30% of the flour particles are smaller than 10 μm.

31. The soy flour according to claim 22, characterised in that the trypsin-inhibitor content of the soy flour produced is less than 50% as high as the trypsin-inhibitor content of the original soy beans.

32. The soy flour produced via a method according to claim 1.

33. Use of the soy flour according to claim 22 as an additive for food products, such as milk products, fruit products, beverages, soups, pasta, nutrition bars, meat substitute, snacks, frozen desserts and bakery products.
